(19) United States
(12) Patent Application Publication
(10) Pub. No.: US 2004/0079641 A1
(43) Pub. Date: Apr. 29, 2004

(54) Curved-film mold for preparation of electrophoresis gels

(76) Inventor: Qi-Feng Ma, Rancho Palos Verdes, CA (US)

Correspondence Address: Qi-Feng Ma, Archidex, Suite 101, 2311 West 205th Street, Torrance, CA, 90501, US

(21) Appl. No.: 10/662,687

(22) Filed: Sep. 15, 2003

Related U.S. Application Data
(60) Provisional application No. 60/415,485, filed on Oct. 2, 2002.

(51) Int. Cl. G01N 27/26

(52) U.S. Cl. 204/615; 204/470

(57) ABSTRACT

A gel mold for electrophoresis is constructed by binding a front film and a rear film onto the opposing faces of a frame of U-shape or four-sided shape. Said front film, rear film, and frame bend to the same direction with the same degree of curvature to form a curved chamber wherein an electrophoresis gel is prepared. There are a first opening on the top of said chamber and a second opening(s) on the bottom of said chamber for conducting electricity. Said gel mold is structurally stable due to the curved structure and is more efficient in heat dissipation due to the thin film, resulting in shorter run time, less waste, and better resolution.

### PRIORITY CLAIM

This application claims benefit of priority of U.S. Provisional Application serial No. 60/415,485 filed on Oct. 2, 2002 titled “Curved-Film Gel Mold For Electrophoresis”

### FIELD OF THE APPLICATION

The present invention relates to gel electrophoresis. More specifically, it relates to a mold for preparation of electrophoresis gels.

### BACKGROUND OF THE INVENTION

Slab gel electrophoresis is used for separation of charged macromolecules and is an indispensable tool for life science. The commonly used gels are made of polyacrylamide, agarose, and cellulose. A mold is required for preparation of a slab gel for electrophoresis. In the case of polyacrylamide gels, the commonly used mold is made of two rigid plates. Two thin strips are sealed between the two plates on the two opposing vertical sides, forming a thin rectangular chamber with openings at the opposing top and bottom sides. For preparation of a gel slab, the bottom opening of the chamber is temporary sealed and an acrylamide monomer solution with a catalyst is added into the chamber. A comb member is then inserted into the top opening for forming sample wells. The gel slab is ready for electrophoresis after polymerization. During electrophoresis, the bottom seal and the comb member are removed. The top opening is exposed to a solution that is in communication with a cathode. The bottom opening is exposed to a separate solution that is in communication with an anode. Samples are loaded into the sample wells at the top opening of the gel and a DC electric field is applied to the gel to conduct electrophoresis.

The key feature of the plate-type mold is the rigidity. To maintain the mold rigidity, relatively thick plates should be used, slowing down the speed of heat dissipation. Heat is generated within the gel during electrophoresis and needs to be released out through the mold. A thick gel mold has insufficient heat dissipation and results in broad bands with low resolution. To avoid gel overheat, a lower electric power is used in the prior art. Though lower electric power prevents the gel from overheat, it also prolongs the time for electrophoresis.

The rigidity of the mold also restricts the size of the chamber volume. It is known that the volume of a polyacrylamide gel expands up to 30% during storage. The rigid plate-type mold prevents this expansion and results in uneven band pattern. Besides, the thick plate mold also consumes more plastic material that is not favorable environmentally and economically.

To avoid the disadvantages of the rigid mold, U.S. Pat. No. 5,753,095 describes a gel mold of plastic film. The plastic film is bound to a rectangular frame to form a flat surface. Two bound films are assembled to form a mold in a way similar to the conventional mold with two plates. Although the problems of the rigid mold are solved, the gel and the plastic films tend to separate, causing sample leakage during electrophoresis. In fact, this film mold has never been used practically.

A new gel mold with better heat dissipation, expandable gel volume, less consumption of raw materials, and stable gel-mold contact is thus required.

### BRIEF DESCRIPTION OF THE INVENTION

The author of the present invention prepared a gel in a rectangular gel mold made of two thin plastic films and tested the contact of the films with the gel slab. Tight contact was observed when both films slightly curved to the same direction. But when the two films are flat and parallel, they have a tendency to bend outwardly and cause unpredictable separation between the gel slab and the films when the gel assembly is immerged in buffers, resulting in electrophoresis failure. Based on the observations, the author of the present invention postulated that if the flat rectangular films were replaced with two films slightly curved to the same direction, the unpredictable separation between the gel and the films would be prevented. The author of the present invention designs a gel mold that is assembled with two slightly curved films. The two films are curved to the same direction and in the same degree of curvature. The gel is sandwiched between the two films. The unpredictable separation between the films and the gel slab is prevented by this design. The curved-film gel mold also provides better band pattern, saves electrophoresis time, and consumes less plastic material for production.

### DESCRIPTION OF THE DRAWINGS

FIG. 1a and 1b show one embodiment of the present invention. FIG. 1a illustrates the assembly process; FIG. 1b shows the assembled mold with gel in it.

FIG. 2a and 2b show another embodiment of the present invention. FIG. 2a illustrates the assembly process; FIG. 2b shows the assembled mold with gel in it.

FIG. 3 shows another embodiment of the present invention with gel.

FIG. 4a and 4b show another embodiment of the present invention. FIG. 4a illustrates the assembly process; FIG. 4b shows the assembled mold with gel in it.

### DETAILED DESCRIPTION OF THE PREFERRED EMBODIMENTS

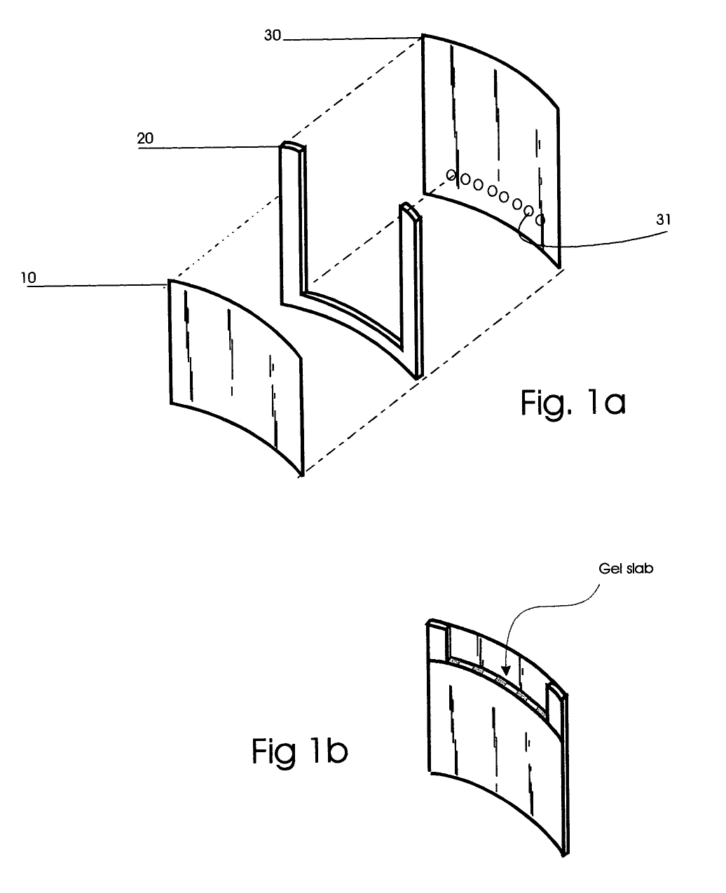

FIG. 1a and 1b show one embodiment of the present invention. The embodiment comprises front film 10, U-shape spacer 20, and rear film 30. The films and the spacer are made of electrically nonconductive materials and are curved to the same direction with the same degree of curvature. The films have a thickness less than 1 millimeter, preferably, less than 0.25 millimeters, and are preferably transparent. Rear film 30 is higher than front film 10 and has a number of holes 31 approximate to its lower side. The films and the spacer are bound together as illustrated in FIG. 1a to form a gel mold shown in FIG. 1b. The gel mold has a curved chamber between front film 10 and rear film 30 with a thickness equal to the thickness of the spacer. The chamber has a top opening at the upper side of front film 10 and a bottom opening through hole 31 of rear film 30. To prepare a gel, hole 31 is temporally sealed by a conventional means, such as a tape. A gelable solution is added into the chamber and a comb member of multiple teeth (not shown) is inserted into the gelable solution at the top opening. The gelable solution forms a gel slab in the chamber and in-between the teeth of the comb member. The gelable solution can also be added into the gel chamber through holes 31 if the gel mold is placed into a properly designed container. Upon electrophoresis, the seal for hole 31 and the comb member are removed from the gel mold, leaving an upper gel exposure with sample wells and a lower gel exposure through holes 31 (FIG. 1b). The upper gel exposure is in contact with a first buffer in electrical communication with a cathode. The lower gel exposure is in contact with a second buffer in electrical communication with an anode. Samples are loaded into the sample wells and a DC electric field is applied to the gel through the electrodes for electrophoresis.

The embodiment shown in FIG. 1 can be modified in many ways. For example, U-shaped spacer 20 can be constructed into a four-sided spacer to increase the geometrical strength; front film 10 may extends upward from part of its top end to form a U-shaped structure; a combination of a four-sided spacer and a U-shaped front film is definitely beneficial for some applications.

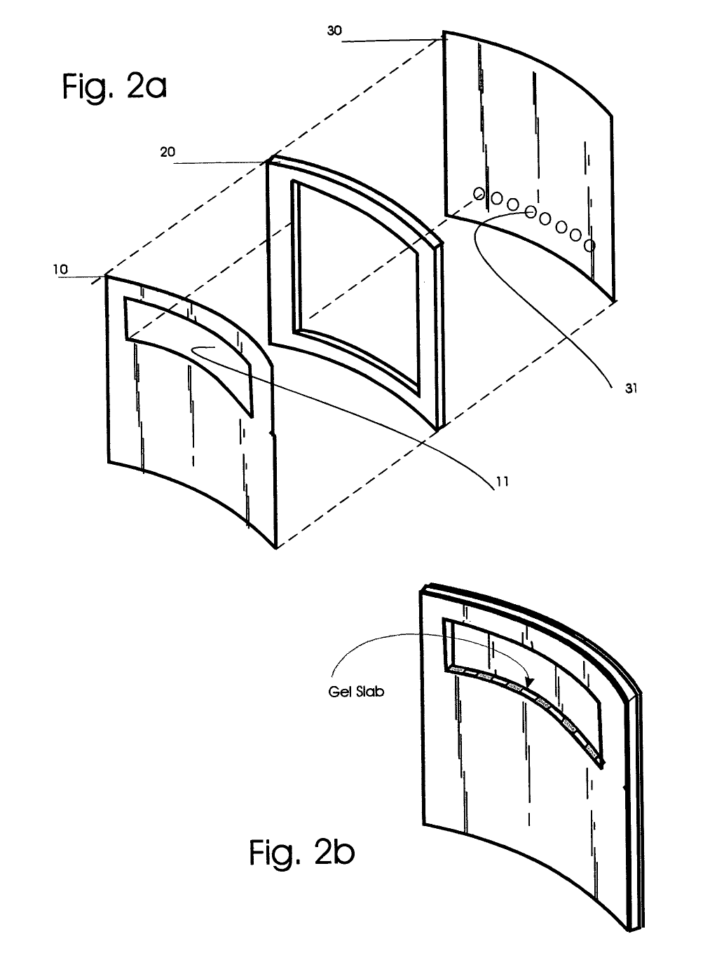

FIG. 2a shows a modification of the embodiment of FIG. 1a. Rear film 30 is the same as in FIG. 1a. U-shaped pacer 20 changes to a four-sided spacer. Front film 10 has the same height as rear film 30 and opens a rectangular window 11 at the upper half of the film. The rest is the same as the embodiment shown in FIG. 1a and an assembled gel mold with a gel slab is shown in FIG. 2b. The curved structure of the embodiment in FIG. 2b is stronger than the embodiment in FIG. 1b.

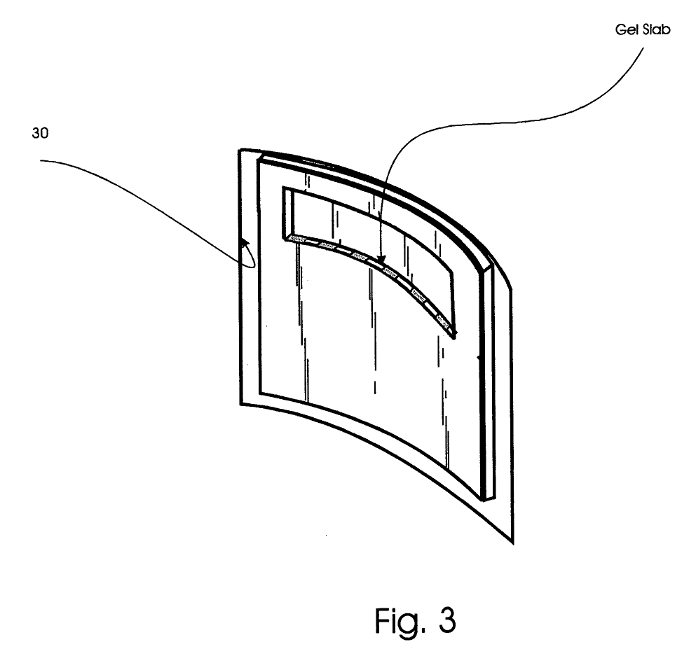

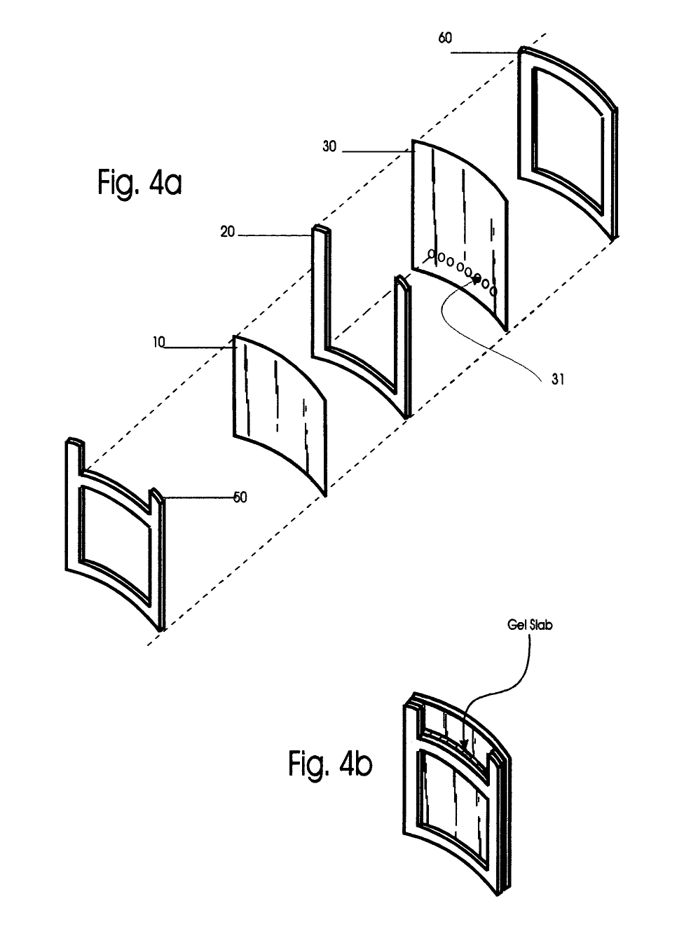

FIG. 3 shows a modification of the embodiment shown in FIG. 2a and 2b. Instead of the same width and the same height as the spacer, the rear film 30 extends a distance sideward and bottomward. The extending section is used for clamping the gel mold onto an electrophoresis apparatus. All the gel molds of the prior arts are clamped at the spacer position, which affects the shape of the two plates of the mold and the gel slab sandwiched in-between. The changes in the gel shape and the mold shape affect the band pattern and even cause a separation between the gel and the gel mold. This influence is more significant when flexible films are used as a gel mold. Since the gel mold shown in FIG. 3 is clamped at the extending section of the rear film and does not touch the spacer, the shapes of the films and the gel are not affected, resulting in a problem-free sealing process with a better gel performance. The area extension on the rear film for clamping is not restricted to the embodiment of FIG. 2a. It can be applied to the embodiment of FIG. 1a, and FIG. 4a of the present invention. It can also be applied to other gel molds of the prior arts, such as rigid plate-type molds and flat-film gel molds.

FIG. 4a and 4b is another embodiment of the present invention. The embodiment comprises front film 10, spacer 20, rear film 30, front frame 50, and rear frame 60. Front film 10, spacer 20, rear film 30 are the same as the embodiment described in FIG. 1a. Rear frame 60 is a curved four-sided frame and has a height the same as the height of the spacer. Front frame is a four-sided frame and has the same height as the front film 10. A U-shaped protrusion may extend from the upper side of the frame. The frames, films, and the spacer are bound in a way illustrated in FIG. 4a and form a gel mold as shown in FIG. 4b. The gel preparation and the electrophoresis process resemble the embodiment in FIG. 1a. The advantage of the embodiment in FIG. 4a is its stable structure. The spacer in FIG. 4a may be eliminated and the gel thickness may be controlled by a U-shape projection along the edge of the rear or front frame, which is easily understood by the ones familiar to the art.

Back frame 60 and front frame 50 may take the same shape as spacer 20. The top side of spacer 20 and the top side of front frame 50 may have an additional strip to close their top openings of the respective frames. The present invention allows the modifications to the exemplary embodiments shown in the Figures as long as the modifications fall into the curved structure of a gel mold that is the key feature of the present invention.

The materials for construction of front film 10 and rear film 30 in the figures of the present invention can be any thin plastic films that include polyester, polyurethane, polycarbonate, polyacetate, polysterene and many other polymers. The films are preferably transparent with a thickness less than 0.5 mm. Since most of the plastic materials are hydrophobic and tend to absorb samples during electrophoresis, a layer of hydrophilic coating is preferably coated to the films. The hydrophilic coatings include but are not limited to silicon oxide, aluminum oxide, and polyvinyl alcohol.

The key feature of the present invention is the curved structure of the gel mold enclosed by two thin films that distinguishes itself from the prior art. Thin film is very flexible and structurally unstable. If a gel is enclosed in-between two flat thin films, the two films show unpredictable outward curvature, causing a separate between the gel and the films. The separate between the gel and the films results in sample leakage during electrophoresis and severely affects the electrophoresis results. Though U.S. Pat. No. 5,753,095 provides a four-sided frames on two flat films, the unexpected separate between the gel and the films could not be prevented in the middle section of the films. In the present invention, the two films have a curvature towards the same direction, preventing the separate between the films and the gel and making the film-type gel mold practical.

The film-type gel mold of the present invention has several advantages. Since a film is much thinner than the plate in the conventional gel mold, the film gel mold is an efficient heat conductor and the heat in the gel during electrophoresis can be quickly dissipated out. Fast heat dissipation results in better resolution and a uniform band pattern. It also allows application of higher electric field to the gel and significantly reduces electrophoresis time.

The polyacrylamide electrophoresis gels have the tendency of swelling during storage. In the conventional plate-type gel mold, the gel cannot swell by increasing its thickness. Instead, it often expands longitudinally, causing an irregular band pattern and low resolution. Since the mold of the present invention is made of flexible films and allows increase of gel thickness, the problem caused by gel swelling is solved.

Film-type gel mold of the present invention uses much less materials than the conventional plate-type gel mold. This not only decreases production cost, but also significantly reduces waste. Since the gel mold is a disposable component in pre-cast electrophoresis gel, decrease of waste is environmentally favorable.

The pre-cast gels prepared by the present invention is compact and occupies less than half of the storage space for the conventional pre-cast gels. Since the gel needs to be refrigerated during storage, it saves refrigerating space for storage, which is beneficial both for the inventory of the manufacturers and for the storage of the end users.

### EXAMPLE 1

Gel prepared in-between two flat films. A film gel mold is assembled in a similar way as illustrated in FIG. 4a except that all the members are flat. A 10% polyacrylamide gel was prepared in the film gel mold and run according to the Laemmli method. Pig serum of different concentrations was used as electrophoresis samples. Six gels were prepared and run under the same condition. Five of them showed sample leakage between the gel and the films during electrophoresis. One of them showed sample leakage during sample loading.

### EXAMPLE 2

Gel prepared in the film-type gel mold of the present invention. The gel mold is prepared as shown in FIG. 1a. Other process was the same as described in example 1. Six gels were prepared and run under the same condition. No sample leakages were observed.

### EXAMPLE 3

Gel expansion experiments. A conventional plate-type gel mold and a film-type gel mold described in FIG. 1a were used for gel preparation. Three gels were prepared by each mold in the same way as in example 1. The gels were stored at room temperature and were analyzed at day 1, day 5 and day 10 after the preparation of the gels. It was observed that the gel in the plate-type gel mold and the gel in the film-type gel mold gave similar electrophoresis results after 1-day storage. But the gel in the plate-type gel mold showed distortion in sample bands after 10-days storage while the gel in the film-type gel mold had no change in gel performance.

What is claimed is:

1. A gel mold comprising a curved front film, a curved 4-sided middle frame, and a curved rear film wherein said front film, said middle frame, and said rear film bend to the same direction with the same degree of curvature and share the same size;
wherein said front film and said rear film are spaced apart by said middle frame and bound to said middle frame at their periphery, forming a curved rectangular cassette having opposing top and bottom ends, two lateral sides, a front face, a back face, and a chamber in-between said films;
wherein said chamber is for receiving an electrophoresis gel and has a first opening in said front film approximate to the top end of said cassette and a second opening in said rear film approximate to the bottom end of said cassette, said first opening being formed by cutting an aperture in said front film, said second opening being constructed into at least one hole in said rear film, said electrophoresis gel in said chamber extending from said second opening to said first opening and having a first gel exposure at said first opening and a second gel exposure at said second opening.

2. A gel mold of claim 1 wherein said rear film is larger in size than said middle frame and extends outward from at least one side of said cassette.

3. A gel mold of claim 1 wherein said front film is larger in size than said middle frame and extends outward from at least one side of said cassette.

4. A gel mold of claim 1 wherein said middle frame is of U-shape with its open side at the top end of said cassette, said first opening of said chamber being created by a U-shape cut in said front film from said top end of said cassette.

5. A gel mold of claim 4 wherein said rear film is larger in size than said middle frame and extends outward from at least one side of said cassette.

6. A gel mold of claim 4 wherein said front film is larger in size than said middle frame and extends outward from at least one side of said cassette.

7. A gel mold of claim 1 wherein said cassette is structurally strengthened by a curved front frame and a curved rear frame, said front frame and rear frame taking the shape of said middle frame and binding to the periphery of said cassette at the front face and the back face of the cassette, respectively.

8. A gel mold of claim 7 wherein said front frame has an additional curved strip connecting two lateral sides of the front frame, said curved strip locating at said first opening of said cassette and binding to said front film.

9. A gel mold of claim 4 wherein said cassette is structurally strengthened by a curved front frame and a curved rear frame, said front frame and rear frame taking the shape of said middle frame and binding to the periphery of said cassette at the front face and the back face of the cassette, respectively.

10. A gel mold of claim 9 wherein said front frame has an additional curved strip connecting two lateral sides of the front frame, said curved strip locating at said first opening of said cassette and binding to said front film.

11. A gel mold of claim 10 wherein said back frame has an additional curved strip connecting two lateral sides of the back frame, said curved strip locating at said top end of said cassette and binding to said rear film.

12. A gel medium prepared in the gel mold of claim 1 comprising a curved front film, a curved 4-sided middle frame, and a curved rear film wherein said front film, said middle frame, and said rear film bend to the same direction with the same degree of curvature and share the same size;
wherein said front film and said rear film are spaced apart by said middle frame and bound to said middle frame at their periphery, forming a curved rectangular cassette having opposing top and bottom ends, two lateral sides, a front face, a back face, and a chamber in-between said films;
wherein said chamber is for receiving an electrophoresis gel and has a first opening in said front film approximate to the top end of said cassette and a second opening in said rear film approximate to the bottom end of said cassette, said first opening being formed by cutting an aperture in said front film, said second opening being constructed into at least one hole in said rear film, said electrophoresis gel in said chamber extending from said second opening to said first opening and having a first gel exposure at said first opening and a second gel exposure at said second opening.

13. A gel medium of claim 12 wherein said rear film is larger in size than said middle frame and extends outward from at least one side of said cassette.

14. A gel medium of claim 12 wherein said front film is larger in size than said middle frame and extends outward from at least one side of said cassette.

15. A gel medium of claim 12 wherein said middle frame is of U-shape with its open side at the top end of said cassette, said first opening of said chamber being created by a U-shape cut in said front film from said top end of said cassette.

16. A gel medium of claim 15 wherein said rear film is larger in size than said middle frame and extends outward from at least one side of said cassette.

17. A gel medium of claim 15 wherein said front film is larger in size than said middle frame and extends outward from at least one side of said cassette.

18. A gel medium of claim 12 wherein said cassette is structurally strengthened by a curved front frame and a curved rear frame, said front frame and rear frame taking the shape of said middle frame and binding to the periphery of said cassette at the front face and the back face of the cassette, respectively.

19. A gel medium of claim 18 wherein said front frame has an additional curved strip connecting two lateral sides of the front frame, said curved strip locating at said first opening of said cassette and binding to said front film.

20. A gel medium of claim 15 wherein said cassette is structurally strengthened by a curved front frame and a curved rear frame, said front frame and rear frame taking the shape of said middle frame and binding to the periphery of said cassette at the front face and the back face of the cassette, respectively.

21. A gel medium of claim 20 wherein said front frame has an additional curved strip connecting two lateral sides of the front frame, said curved strip locating at said first opening of said cassette and binding to said front film.

22. A gel medium of claim 21 wherein said rear frame has an additional curved strip connecting two lateral sides of the rear frame, said curved strip locating at said top end of said cassette and binding to said rear film.

23. A gel medium prepared in the gel mold of claim 1 comprising a curved front film, a curved 4-sided middle frame, and a curved rear film wherein said front film, said middle frame, and said rear film bend to the same direction with the same degree of curvature and share the same size;
Wherein said front film and said rear film are stably coated with a layer of hydrophilic materials that include silicon oxide, polyvinyl alcohols, aluminum oxide, and other hydrophilic polymers.
wherein said front film and said rear film are spaced apart by said middle frame and bound to said middle frame at their periphery, forming a curved rectangular cassette having opposing top and bottom ends, two lateral sides, a front face, a back face, and a chamber in-between said films;
wherein said chamber is for receiving an electrophoresis gel and has a first opening in said front film approximate to the top end of said cassette and a second opening in said rear film approximate to the bottom end of said cassette, said first opening being formed by cutting an aperture in said front film, said second opening being constructed into at least one hole in said rear film, said electrophoresis gel in said chamber extending from said second opening to said first opening and having a first gel exposure at said first opening and a second gel exposure at said second opening.

24. A gel medium of claim 23 wherein said rear film is larger in size than said middle frame and extends outward from at least one side of said cassette.

25. A gel medium of claim 23 wherein said front film is larger in size than said middle frame and extends outward from at least one side of said cassette.

26. A gel medium of claim 23 wherein said middle frame is of U-shape with its open side at the top end of said cassette, said first opening of said chamber being created by a U-shape cut in said front film from said top end of said cassette.

27. A gel medium of claim 26 wherein said rear film is larger in size than said middle frame and extends outward from at least one side of said cassette.

28. A gel medium of claim 26 wherein said front film is larger in size than said middle frame and extends outward from at least one side of said cassette.

29. A gel medium of claim 23 wherein said cassette is structurally strengthened by a curved front frame and a curved rear frame, said front frame and rear frame taking the shape of said middle frame and binding to the periphery of said cassette at the front face and the back face of the cassette, respectively.

30. A gel medium of claim 29 wherein said front frame has an additional curved strip connecting two lateral sides of the front frame, said curved strip locating at said first opening of said cassette and binding to said front film.

31. A gel medium of claim 26 wherein said cassette is structurally strengthened by a curved front frame and a curved rear frame, said front frame and rear frame taking the shape of said middle frame and binding to the periphery of said cassette at the front face and the back face of the cassette, respectively.

32. A gel medium of claim 31 wherein said front frame has an additional curved strip connecting two lateral sides of the front frame, said curved strip locating at said first opening of said cassette and binding to said front film.

33. A gel medium of claim 32 wherein said rear frame has an additional curved strip connecting two lateral sides of the rear frame, said curved strip locating at said top end of said cassette and binding to said rear film.
